(19) United States
(12) Patent Application Publication
(10) Pub. No.: US 2023/0048594 A1
(43) Pub. Date: Feb. 16, 2023

(54) INFORMATION PROCESSING DEVICE, INFORMATION PROCESSING METHOD, AND RECORDING MEDIUM

(71) Applicant: NEC CORPORATION, Minato-ku, Tokyo (JP)

(72) Inventor: Yoshikazu WATANABE, Tokyo (JP)

(73) Assignee: NEC Corporation, Minato-ku, Tokyo (JP)

(21) Appl. No.: 17/792,220

(22) PCT Filed: Jan. 20, 2020
(86) PCT No.: PCT/JP2020/001628

§ 371 Date: Jul. 12, 2022

(51) Int. Cl. G06V 10/776; G06V 10/22; G06V 10/74; G06V 10/774; G06V 10/26

(52) U.S. Cl. CPC G06V 10/776; G06V 10/22; G06V 10/761; G06V 10/774; G06V 10/267

(57) ABSTRACT

An information processing device according to the present invention includes: a memory; and at least one processor coupled to the memory. The processor performs operations. The operations includes: selecting a base image from a base data set that is a set of images including a target region that includes an object that is a target of machine learning and a background region that does not include an object that is a target of the machine learning; generating a processing target image that is a duplicate of the selected base image; selecting the target region included in another image included in the base data set; synthesizing an image of the selected target region with the processing target image; and generating a data set that is a set of the processing target images in which a predetermined number of the target regions are synthesized.

### TECHNICAL FIELD

The present invention relates to information processing, and particularly relates to data generation in machine learning.

### BACKGROUND ART

One of the main tasks using machine learning is an object detection task in an image. The object detection task is a task of generating a list of sets of positions and classes (types) of detection target objects present in an image. In recent years, among machine learning, an object detection task using deep-learning has been widely used (see, for example, Non Patent Literatures (NPLs) 1 to 3).

In the machine learning of the object detection task, learning images and information on the detection target object in each image are given as correct answer data.

The information on the detection target object is selected according to the specification of the object detection task. For example, the information on the detection target object includes coordinates (bounding box: BB) of four vertices of a rectangular region in which a target object appears and a class of the detection target object. In the following description, the BB and the class will be used as an example of the information on the detection target object.

Then, the object detection task generates a learned model as a result of machine learning using deep-learning by using the learning images and the information on the detection target object.

Then, the object detection task applies the learned model to an image including the detection target object, infers the detection target object in the image, and outputs the BB and the class for each detection target object included in the image. There is a case that the object detection task outputs an evaluation result (e.g., confidence) of a result of object detection together with the BB and the class.

For example, a person and vehicle monitoring system can be constructed by inputting an image from a surveillance camera to the object detection task, and using the positions and the classes of the person and the vehicle appearing in the image of the surveillance camera detected by the object detection task.

### CITATION LIST

### Non Patent Literature

[NPL 1] Shaoqing Ren, Kaiming He, Ross Girshick, Jian Sun, “Faster R-CNN: Towards Real-Time Object Detection with Region Proposal Networks”, [online], 6 Jan. 2016, Comel University, [Searched on Oct. 16, 2019], Internet <UREhttps://arxiv.org/abs/1506.01497>
[NPL 2] Wei Liu, Dragomir Anguelov, Dumitru Erhan, Christian Szegedy, Scott Reed, Cheng-Yang Fu, Alexander C. Berg, “SSD: Single Shot MultiBox Detector”, [online], 29 Dec. 2016, Comel University, [Searched on Oct. 16, 2019], Internet, <UREhttps://arxiv.org/abs/1512.02325>
[NPL 3] Tsung-Yi Lin, Priya Goyal, Ross Girshick, Kaiming He, Piotr Dollar, “Focal Loss for Dense Object Detection”, [online], 2 Feb. 2018, Comel University, [Searched on Oct. 16, 2019], Internet, <URL:https//arxiv.org/abs/1708.02002>

### SUMMARY OF INVENTION

### Technical Problem

Machine learning in an object detection task generally has a heavy calculation load and requires a long processing time.

For example, in machine learning in an object detection task using deep-learning, it is necessary to update a weight in a neural network by repeating the following operations for an image of correct answer data to obtain a final learned model.

(1) Infer the class and BB for an image of correct answer data.

(2) Calculate an error between the class and the BB of the correct answer data and the class and the BB of the inference result.

(3) Update the weight based on the calculation of the error (back propagation).

The size of the image of the correct answer data in the object detection task is often larger than the size of the image in a case of a task (e.g., an image identification task) using other machine learning. Therefore, in the object detection task, the calculation loads of the above (1) and (3) are often heavier than those of other tasks using machine learning.

Since the object detection task executes machine learning using the image of correct answer data, the object detection task executes the machine learning for the class and the BB of the detection target object, and also executes the machine learning for the background, which is the part where the detection target object is not present. However, the machine learning for the background has a limited contribution to improvement in accuracy of machine learning.

In general, the proportion of the area occupied by the detection target object in the image included in the correct answer data is not so large (e.g., about several dozen %). That is, in general, the background occupies a large area in the image included in the correct answer data.

Therefore, in order to improve the accuracy of machine learning, many techniques using object detection tasks perform processing so as not to perform the machine learning on the background portion, or executes the machine learning with a reduced priority.

In the case of a technique of not performing machine learning on the background portion, the operation of (3) may be omitted for the background portion. However, the operation of (1) is executed regardless of whether to be the background. That is, an operation that contributes little to the accuracy of the machine learning is executed.

In the case of a technique of performing machine learning with a lowered priority of the background portion, calculation in the operation of (3) is executed, but processing of reducing the contribution of the calculation result to update of the weight is executed. That is, also in this case, the machine learning in the background portion included in the image of correct answer data contributes little to improvement (e.g., update of weight) of the result of the machine learning in spite of consumption of a calculation resource.

In any of the above cases, since there are many backgrounds in the image of the correct answer data, the object detection task cannot effectively utilize the calculation resource in the machine learning. That is, in the object detection task, use efficiency (e.g., an improvement rate with respect to a result of machine learning per calculation amount) of the calculation resource becomes limited. As a result, in order to improve accuracy, a long processing time is required for machine learning.

The technologies described in NPLs 1 to 3 are not related to processing of a background portion, and therefore do not improve the above problem.

An object of the present invention is to provide an information processing device and the like that solve the above problem and improve use efficiency of the calculation resource in machine learning.

### Solution to Problem

An information processing device according to one aspect of the present invention includes:

a base image selection means configured to select a base image from a base data set that is a set of images including a target region that includes an object that is a target of machine learning and a background region that does not include an object that is a target of the machine learning, and configured to generate a processing target image that is a duplicate of the selected base image;

a target region selection means configured to select the target region included in another image included in the base data set;

an image synthesis means configured to synthesize an image of the selected target region with the processing target image; and

a data set generation control means configured to control the base image selection means, the target region selection means, and the image synthesis means to generate a data set that is a set of the processing target images in which a predetermined number of the target regions are synthesized.

An information processing method according to one aspect of the present invention includes:

selecting a base image from a base data set that is a set of images including a target region that includes an object that is a target of machine learning and a background region that does not include an object that is a target of the machine learning, and generating a processing target image that is a duplicate of the selected base image;

selecting the target region included in another image included in the base data set;

synthesizing an image of the selected target region with the processing target image; and

generating a data set that is a set of the processing target images in which a predetermined number of the target regions are synthesized.

A recording medium according to one aspect of the present invention records a program that causes a computer to execute:

processing of selecting a base image from a base data set that is a set of images including a target region that includes an object that is a target of machine learning and a background region that does not include an object that is a target of the machine learning, and generating a processing target image that is a duplicate of the selected base image;

processing of selecting the target region included in another image included in the base data set;

processing of synthesizing an image of the selected target region with the processing target image; and

processing of generating a data set that is a set of the processing target images in which a predetermined number of the target regions are synthesized.

### Advantageous Effects of Invention

Use of the present invention can achieve an effect of improving use efficiency of a calculation resource in machine learning.

### BRIEF DESCRIPTION OF DRAWINGS

FIG. 1 is a block diagram illustrating an example of a configuration of an information processing device according to a first example embodiment.

FIG. 2 is a block diagram illustrating an example of a configuration of a data set generation unit according to the first example embodiment.

FIG. 3 is a flowchart illustrating an example of operation of machine learning in the information processing device according to the first example embodiment.

FIG. 4 is a flowchart illustrating an example of operation of the data set generation unit in the information processing device according to the first example embodiment.

FIG. 5 is a block diagram illustrating an example of a configuration of an information processing device according to a second example embodiment.

FIG. 6 is a block diagram illustrating an example of a configuration of a data set generation unit according to the second example embodiment.

FIG. 7 is a flowchart illustrating an example of operation of machine learning in the information processing device according to the second example embodiment.

FIG. 8 is a diagram illustrating an example of a subset.

FIG. 9 is a diagram for explaining an image generated by the data set generation unit according to the first example embodiment.

FIG. 10 is a block diagram illustrating an example of a hardware configuration.

FIG. 11 is a block diagram illustrating an example of an outline of an example embodiment.

FIG. 12 is a diagram illustrating an example of a configuration of an information processing system including the information processing device.

### EXAMPLE EMBODIMENT

Example embodiments of the present invention will be described below with reference to the drawings.

The drawings are for describing example embodiments. However, the present invention is not limited to the description of the drawings. Similar configurations in the drawings are denoted by the same reference numerals, and repeated description of the configurations are sometimes omitted. In the drawings used for the following description, there is a case where the configuration of a part not related to the description of the example embodiment is omitted and not illustrated.

### First Example Embodiment

The first example embodiment will be described below with reference to the drawings.

[Description of Configuration]

First, the configuration of the first example embodiment will be described with reference to the drawings.

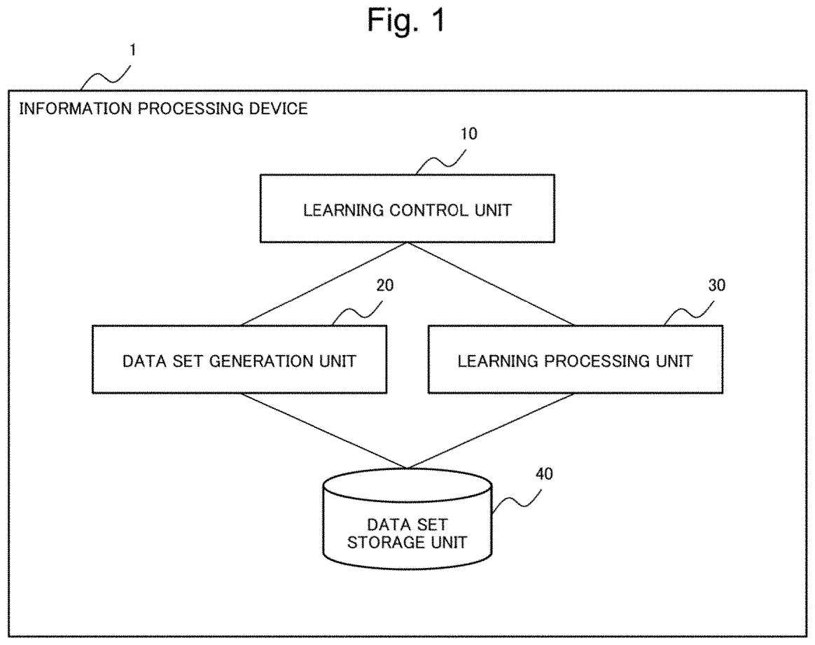

FIG. 1 is a block diagram illustrating an example of the configuration of an information processing device 1 according to the first example embodiment.

The information processing device 1 includes a learning control unit 10, a data set generation unit 20, a learning processing unit 30, and a data set storage unit 40. The number of constituent elements and the connection relationship illustrated in FIG. 1 are an example. For example, the information processing device 1 may include a plurality of the data set generation units 20 or a plurality of the learning processing units 30.

The information processing device 1 may be configured using a computer device including a central processing unit (CPU), a main memory, and a secondary storage device. In this case, the constituent elements of the information processing device 1 illustrated in FIG. 1 are implemented using a CPU or the like. The hardware configuration will be described later.

The learning control unit 10 controls each component in order for the information processing device 1 to execute machine learning (e.g., machine learning in an object detection task).

Specifically, the learning control unit 10 instructs the data set generation unit 20 to generate a data set used for machine learning. Then, the learning control unit 10 instructs the learning processing unit 30 to perform machine learning using the generated data set.

A trigger for start of control of the learning control unit 10 and a parameter associated with the instruction transmitted by the learning control unit 10 to each component are discretionary. The learning control unit 10 may be given a trigger and a parameter from an operator, for example. Alternatively, the learning control unit 10 may execute control in response to transmission of information such as a parameter from another device (not illustrated) communicably connected to the information processing device 1.

The data set storage unit 40 stores information used by the data set generation unit 20 and/or the learning processing unit 30 on the basis of the instruction. The data set storage unit 40 may store information generated by the data set generation unit 20 and/or the learning processing unit 30. The data set storage unit 40 may store parameters.

For example, the data set storage unit 40 may store the data set generated by the data set generation unit 20. Alternatively, the data set storage unit 40 may store a base data set (details will be described later) given from the operator of the information processing device 1. Alternatively, the data set storage unit 40 may store information (e.g., a parameter and/or a base data set) received from another device (not illustrated) communicably connected to the information processing device 1 as necessary.

The data set storage unit 40 may store information (e.g., a data set for comparison) for evaluating a result of machine learning in addition to storing information (e.g., a data set) used for machine learning.

In the following description, the data set generation unit 20 generates a data set by using the base data set stored in the data set storage unit 40. However, the first example embodiment is not limited to this.

For example, the data set generation unit 20 may acquire at least a part of the base data set from a configuration different from the data set storage unit 40 or an external device.

The base data set and the information included in the data set are set in accordance with machine learning in the information processing device 1. The base data set and the data set include, for example, the following information.

(1) An image (e.g., Joint Photographic Experts Group (JPEG) data).

(2) Meta information on an image (e.g., a time stamp, a data size, an image size, and/or color information).

(3) Information on the detection target object (object that is a detection target by machine learning) included in an image.

The information regarding the detection target object is discretionary, and includes, for example, the following information.

(3)-1 A region (target region) including an object: for example, coordinates of four vertices of a rectangular region in which the object appears.

(3)-2 The class of the object (e.g., an identifier of the class or the name of the class).

(3)-3 The number of detection target objects per image.

(4) A correspondence relationship between the identifier and the name of the class.

The data set is data (e.g., correct answer data) used for machine learning. Therefore, the data set generally includes a plurality of images. For example, the data set includes several thousands to tens of thousands of images.

The images may be compressed data.

The unit of image storage is discretionary. Each image may be stored as a single data file. Alternatively, a plurality of images may be collectively stored in one data file.

The image may be stored and managed using a hierarchical structure such as a directory or a folder. When there are a plurality of base data sets and/or data sets, the base data sets and/or the data sets may also be stored and managed using a hierarchical structure such as a directory or a folder.

The data set generation unit 20 generates a data set used for machine learning in the learning processing unit 30 on the basis of data (hereinafter, referred to as “base data set”) including an image of the detection target object. The data set generation unit 20 may store the generated data set in the data set storage unit 40.

More specifically, the data set generation unit 20 receives designation of the base data set and parameters related to generation of the data set from the learning control unit 10 and generates the data set.

The base data set is a set of images including a region (target region) of an image of a detection target object that is a detection target of machine learning and a region (hereinafter, referred to as “background region”) that is not a detection target of machine learning.

The data set generation unit 20 generates a data set used for machine learning by using the following operation on the basis of the base data set.

(1) The data set generation unit 20 selects, from the base data set, an image (hereinafter, referred to as “base image”) to become a basis (base) in the following processing. The data set generation unit 20 may select a plurality of base images. Then, the data set generation unit 20 generates a duplication (hereinafter, referred to as “processing target image”) of the selected base image.

(2) The data set generation unit 20 applies the following operation to the processing target image to synthesize the target region with the processing target image.

(2)-1 The data set generation unit 20 selects a region (target region) including the detection target object that is a target of machine learning in a region corresponding to the background region of a processing target image from another image (image different from the selected base image) included in the base data set.

In a case where the selected image includes a plurality of target regions, the data set generation unit 20 may select one target region or may select a plurality of target regions.

(2)-2 The data set generation unit 20 synthesizes the image of the selected target region with the processing target image. The data set generation unit 20 adds, to the processing target image, information (e.g., the coordinates of the target region, the class of the included object, and the like) of the selected target region.

(3) The data set generation unit 20 generates a data set that is a set of synthesized processing target images.

(4) The data set generation unit 20 transmits the generated data set to the learning processing unit 30 or stores the generated data set in the data set storage unit 40.

Details of the operation in the data set generation unit 20 will be described later.

The learning processing unit 30 executes machine learning by using the data set (e.g., the data set stored in the data set storage unit 40) generated by the data set generation unit 20 and generates a learned model (e.g., an object detection model). The learning processing unit 30 may use deep-learning as machine learning.

The learning processing unit 30 may evaluate the result of machine learning. For example, the learning processing unit 30 may calculate the recognition accuracy of the detection target object in the result of machine learning.

Then, the learning processing unit 30 stores the generated learned model in a predetermined storage unit (e.g., the data set storage unit 40). Alternatively, the learning processing unit 30 transmits the generated learned model to a predetermined device (e.g., a device that detects a detection target object in an image by using the learned model).

Next, the configuration of the data set generation unit 20 according to the first example embodiment will be described with reference to the drawings.

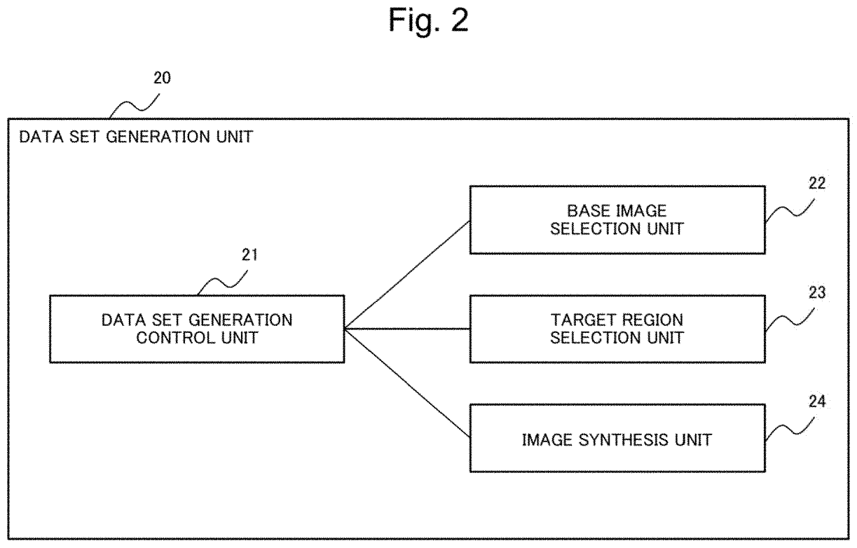

FIG. 2 is a block diagram illustrating an example of the configuration of a data set generation unit 20 according to the first example embodiment.

The data set generation unit 20 includes a data set generation control unit 21, a base image selection unit 22, a target region selection unit 23, and an image synthesis unit 24.

The data set generation control unit 21 controls the components included in the data set generation unit 20 to generate a predetermined number of processing target images from the base data set, and generate a data set that is a set of the generated processing target images.

For example, the data set generation control unit 21 receives a base data set and a parameter related to generation of a data set from the learning control unit 10, controls each unit in the data set generation unit 20, and generates a data set.

The parameter is determined in accordance with the data set to be generated. For example, the data set generation control unit 21 may use the following information as a parameter related to the generation of the data set.

(1) The number of processing target images to be generated (the number of images included in the data set to be generated).

(2) The maximum number of target regions to be synthesized.

The setting range of the maximum number of target regions is discretionary. For example, the maximum number is a maximum number per data set, a maximum number per subset described later, a maximum number per image, a maximum number per class, or a maximum number per image size.

When generating the data set, as the maximum number of target regions to be synthesized, the data set generation control unit 21 may use a value received as a parameter.

However, the data set generation control unit 21 may receive a parameter as a value for calculating the maximum value. For example, as the maximum value, the data set generation control unit 21 may use a value (e.g., a value generated by a random number generation function using a parameter as a seed of a random number) of a random number with the value of the received parameter as a seed. The data set generation control unit 21 may generate a random number for each processing target image.

The data set generation control unit 21 may receive, as the parameter, a parameter that designates whether to use the received parameter as a maximum value or to use the received parameter as a value for calculating the maximum value.

The base image selection unit 22 selects a base image from the base data set and generates a processing target image that is a duplication of the base image.

The base image selection unit 22 may execute preprocessing in the selection.

For example, as preprocessing, the base image selection unit 22 may divide the image included in the base data set into a plurality of image-groups (hereinafter, referred to as “subset”) on the basis of a predetermined criterion (e.g., similarity of the background region).

The determination technique for similar of the background region in the base image selection unit 22 may be selected in accordance with the target image.

The base image selection unit 22 may determine similarity of the background region by using, for example, the following information or a combination of information.

(1) Designation of the operator of the information processing device 1 (the designated image is regarded to have similar backgrounds).

(2) Information set in the image of the base data set (e.g., images captured at the same position are regarded to have similar backgrounds).

(3) Logical position where the image is stored (e.g., images stored in the same directory are regarded to have similar backgrounds).

(4) Image acquisition information (e.g., images with close time stamps are regarded to have similar backgrounds).

(5) Difference in pixel values (e.g., pixel values between images are compared, and images having a difference equal to or less than a predetermined threshold are regarded as having similar backgrounds).

(6) Similarity of background portion (e.g., the background region in the image is extracted, and images in which the similarity in the feature amount of the image of the extracted background region is equal to or more than a predetermined threshold are regarded as having similar backgrounds).

The base image selection unit 22 may select the range of a background region to be compared by using predetermined information (e.g., the distance from the target region or an object included in the background region). However, the base image selection unit 22 may use all the regions other than the target region as the background region.

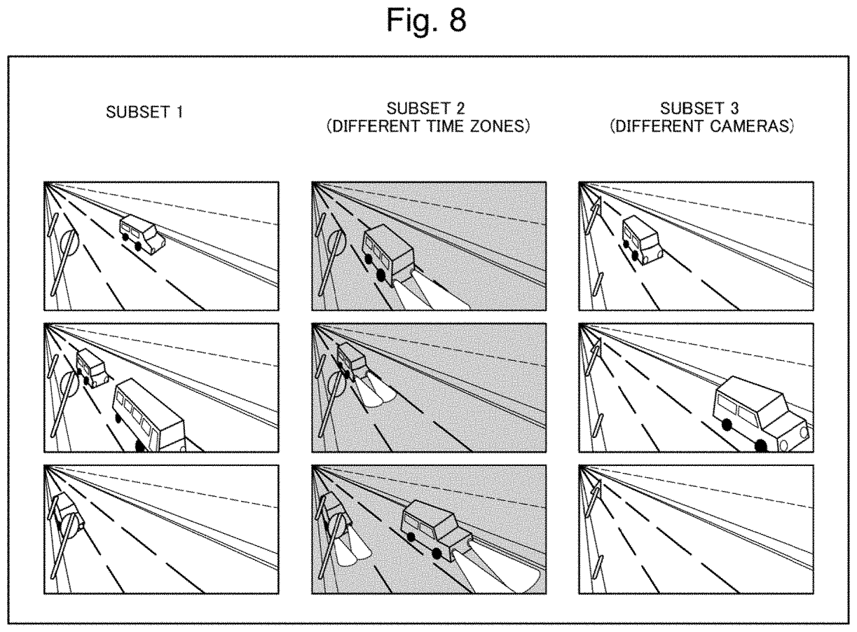

FIG. 8 is a diagram illustrating an example of a subset.

The subset illustrated in FIG. 8 includes nine images. The images illustrated in FIG. 8 are divided into three subsets.

A subset 1 and a subset 2 are images captured by the same camera. However, the images included in the subset 1 are different from the images included in the subset 2 in the time zone of capturing. As a result, the background of the images included in the subset 1 is different from the background of the images included in the subset 2. Therefore, the images included in the subset 1 are different subset from the images included in the subset 2.

The images included in a subset 3 are images captured by a camera different from the camera that captured the subsets 1 and 2. The background of the images included in the subset 3 is different from the background of the images included in the subsets 1 and 2. Therefore, the images included in the subset 3 are divided into subsets different from the images included in the subset 1 and the subset 2.

The base image selection unit 22 may randomly select the base image. Alternatively, the base image selection unit 22 may use a predetermined criterion when selecting the base image. However, the criterion used by the base image selection unit 22 is discretionary. For example, the base image selection unit 22 may select the base image by using any of the following criteria or a combination of the criteria.

(1) Number of Images in Subset

The base image selection unit 22 may select the base image such that the number of images selected from each subset falls within the same number or a range of a predetermined difference.

As the number of images to be selected from the subset, for example, the base image selection unit 22 allocates, to each subset, a value obtained by dividing the number of base images to be selected by the number of subsets. In a case where the number cannot be divided by an integer, the base image selection unit 22 may round the divided value to an appropriate integer such that the total number becomes the number of base images to be selected, and allocate the rounded value to the subset.

Then, when selecting the base image, the base image selection unit 22 selects images of the number of values allocated to the subset from among the subsets. The base image selection unit 22 selects an image in the subset in accordance with a predetermined rule (e.g., round robin or random).

The number of images selected from the subset may be designated by the operator of the information processing device 1. Alternatively, the number of images selected from the subset may be a value proportional to the number of images included in the subset.

(2) Dispersion of Base Images

The base image selection unit 22 may select the base images so that the base images to be used disperse. For example, the base image selection unit 22 may store the history of the selected base image, and select the base image so as not to select the base image (the base image selected in the past) stored in the history.

However, the base image selection unit 22 may select the base image such that other information (e.g., time zone or place) disperses.

(3) Number of Target Regions

The base image selection unit 22 may select an image including many target regions as the base image.

Alternatively, the base image selection unit 22 may preferentially select an image including many target regions including an object of a predetermined class.

The predetermined class is, for example, as follows.

(a) A class designated by the operator.

(b) A class with low frequency of occurrence in the base data set or the data set being generated.

(4) Type of Target Region

The base image selection unit 22 may select the base image so that the number of types (e.g., class, size, and/or image quality of the included detection target object) of target regions included in the image increases. For example, in a case where there are many images with few background regions in the images included in the base data set or the subset, it is assumed that there are many target regions included in the image. In such a case, the base image selection unit 22 may select the base image so that the number of types of target regions included in the image increases.

Then, the base image selection unit 22 generates a duplication (processing target image) of the selected base image.

The target region selection unit 23 selects the target region to be synthesized with the processing target image. More specifically, the target region selection unit 23 selects, in the base data set, an image different from the base image of the duplication source of the processing target image, and selects, in the selected image, a target region included in a region corresponding to the background region of the processing target image.

The target region selection unit 23 selects a target region according to a preset rule. The target region selection unit 23 selects a target region by using, for example, any of the following selections or a combination of selections.

(1) The target region selection unit 23 selects a target region that falls within the background portion of the processing target image being generated.

(2) The target region selection unit 23 selects a target region from another image included in the same subset of the base image.

(3) The target region selection unit 23 selects a target region such that the number of times of selecting the class of the detection target object is equalized within a possible range.

(4) The target region selection unit 23 selects a target region such that the number of times of selecting each target region is equalized within a possible range.

(5) The target region selection unit 23 preferentially selects a target region including a detection target object of a predetermined class. For example, the target region selection unit 23 may preferentially select a class related to an appropriate detection target object as a target of machine learning in the learning processing unit 30.

The predetermined class is discretionary, but may be, for example, the following class.

(a) A class designated by the operator of the information processing device 1.

(b) A class with low frequency of occurrence in the base data set or the data set being generated.

(5) The target region selection unit 23 preferentially selects a target region having a predetermined size. For example, the target region selection unit 23 may select a target region having a size effective in machine learning in the learning processing unit 30.

The predetermined size is discretionary, but may be, for example, the following size.

(a) A size designated by the operator of the information processing device 1.

(b) A size with low frequency of occurrence in the base data set or the data set being generated.

(6) The target region selection unit 23 may preferentially select a target region having a shape (e.g., an aspect ratio of a rectangle) effective for machine learning.

The image synthesis unit 24 synthesizes the target region selected by the target region selection unit 23 with the processing target image.

The synthesis technique used by the image synthesis unit 24 is discretionary.

For example, the image synthesis unit 24 replaces (overwrites) the image of the corresponding region of the processing target image with the image of the selected target region.

The image synthesis unit 24 may use the image of the target region without changing the image. Alternatively, the image synthesis unit 24 may use the image of the target region after changing (magnifying, reducing, deforming the shape, and/or modifying the color).

Alternatively, the image synthesis unit 24 may apply, to the processing target image, a pixel value (e.g., an average value) calculated using the pixel value of the processing target image and the pixel value of the image of the target region.

The image synthesis unit 24 may execute predetermined image processing in image synthesis. An example of the predetermined image processing is correction (blurring, smoothing, and/or the like) of pixels at a boundary of and in the vicinity of a region where an image is synthesized.

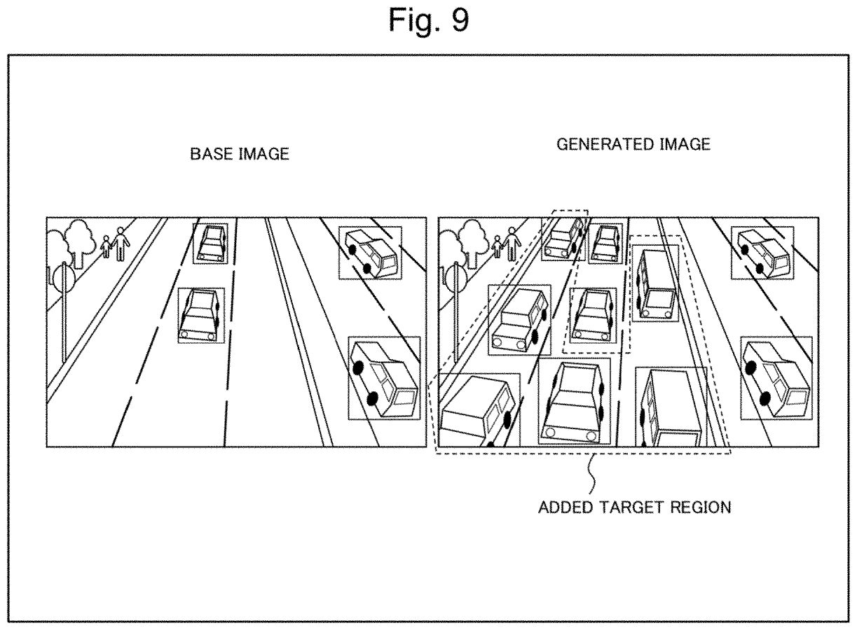

FIG. 9 is a diagram for explaining an image generated by the data set generation unit 20 according to the first example embodiment. In FIG. 9, the target region is surrounded by a rectangle to assist understanding. However, this is for convenience of explanation. The image generated by the data set generation unit 20 needs not include the rectangle surrounding the target region.

The image on the left side in FIG. 9 is an example of the base image (initial state of the processing target image). This base image includes four target regions.

The image on the right side in FIG. 9 is an example of the image (processing target image after synthesizing the target region) synthesized by the image synthesis unit 24. This image includes the four target regions included in the base image and six target regions having been added.

[Description of Operation]

Next, an example of the operation in the information processing device 1 according to the first example embodiment will be described with reference to the drawings.

(A) Operation of Machine Learning

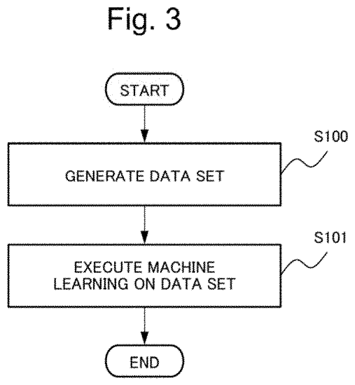

FIG. 3 is a flowchart illustrating an example of the operation of machine learning in the information processing device 1 according to the first example embodiment.

The information processing device 1 starts the operation in response to a predetermined condition. For example, the information processing device 1 starts machine learning in response to an instruction from the operator of the information processing device 1. In this case, at the start of machine learning, the information processing device 1 may receive a parameter necessary for the machine learning from the operator. The information processing device 1 may receive another parameter and information in addition to the parameter necessary for machine learning. For example, the information processing device 1 may receive the base data set from the operator, and may receive a parameter related to generation of the data set.

The learning control unit 10 instructs the data set generation unit 20 to generate a data set. The data set generation unit 20 generates the data set (step S100). The data set generation unit 20 may receive a parameter for generating the data set.

The learning control unit 10 instructs the learning processing unit 30 to perform machine learning using the data set generated in step S100. The learning processing unit 30 executes machine learning by using the data set generated in step S100 (step S101). The learning processing unit 30 may receive a parameter used for machine learning.

When the machine learning in the learning processing unit 30 ends, the information processing device 1 ends the operation.

The learning processing unit 30 may transmit the learned model that is a result of learning to a predetermined device or may store the learned model in the data set storage unit 40.

Alternatively, the learning processing unit 30 may evaluate the result of machine learning.

(B) Operation of Generation of Data Set

Next, the operation by the data set generation unit 20 generating a data set in step S100 of FIG. 3 will be described with reference to the drawings.

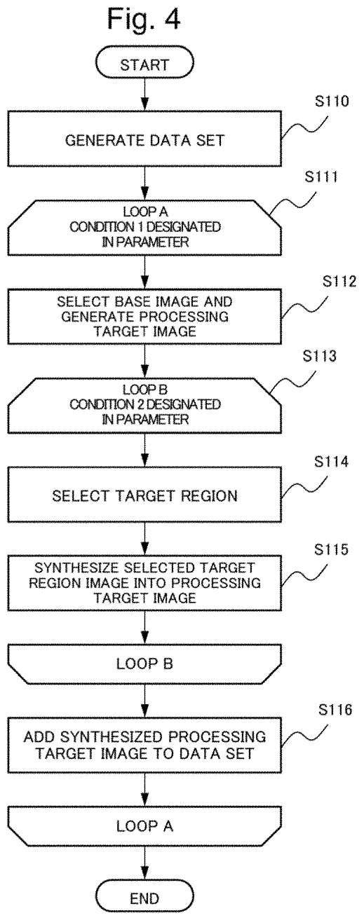

FIG. 4 is a flowchart illustrating an example of the operation of the data set generation unit 20 in the information processing device 1 according to the first example embodiment. In the following description, as an example, it is assumed that the data set generation unit 20 has received a parameter for generating a data set. However, the first example embodiment is not limited to this.

The data set generation control unit 21 generates a data set that stores a processing target image after synthesizing the target region described below (step S110). For example, the data set generation control unit 21 generates a file, a folder, or a database that stores the processing target image.

The data set generation control unit 21 may perform control so as to generate the data set after synthesizing the target region with the processing target image. For example, the data set generation control unit 21 may store the generated processing target image as an individual file, and generate the data set by bringing the processing target images together after generating the processing target images.

The data set generation control unit 21 may initialize the data set as necessary. Alternatively, the data set generation control unit 21 may store the generated data set in the data set storage unit 40.

The generated data set is used for the machine learning executed in step S101. Therefore, the data set generation control unit 21 is only required to generate a data set corresponding to the machine learning to be executed. For example, in a case where the machine learning uses the correspondence between the identifier of the class and the name of the class of the object, the data set generation control unit 21 generates a data set that takes over the correspondence relationship between the identifier of the class and the name of the class included in the base data set. In this case, the data set generation control unit 21 may generate a data set that does not take over at least a part of other information (e.g., information regarding the image, meta information, and the detection target object) included in the base data set.

The data set generation control unit 21 controls the configuration so as to repeat a loop A (steps S112 to S116) until the condition (condition 1) designated by the parameter is satisfied (step S111). For example, the data set generation control unit 21 may use, as the condition 1, a condition that the number of generated processing target images reaches the number designated by the parameter. In this case, the data set generation control unit 21 controls the configuration so as to repeat the loop A until as many processing target images as designated by the parameter are generated.

The base image selection unit 22 selects a base image that is a target of the following operation, and generates a duplication (processing target image) of the selected base image (step S112).

Then, the data set generation control unit 21 controls the configuration so as to repeat a loop B (steps S114 and S115) until the condition (condition 2) indicated by the parameter is satisfied (step S113). For example, as the condition 2, the data set generation control unit 21 may use a condition that the number of selected target regions reaches the number designated by the parameter. In this case, the data set generation control unit 21 controls the configuration so as to repeat the loop B until as many target regions as designated by the parameter is synthesized with the processing target image.

However, in a case where there is no target region satisfying the condition 2 as a target region that can be synthesized with the processing target image in the image (an image other than the selected base image) for selecting the target region, the data set generation control unit 21 may end the loop B even if the condition 2 is not satisfied.

For example, in a case where the background range of the processing target image is narrow and as many target regions as designated by the parameter cannot be synthesized, the data set generation control unit 21 may synthesize the target region within a range where synthesis is possible and end the loop B.

The target region selection unit 23 selects a target region to be synthesized with the processing target image from images other than the target base image among the images included in the base data set (step S114). When selecting the target region in the range of the subset, the target region selection unit 23 selects the target region from the images included in the subset.

The image synthesis unit 24 synthesizes the image of the target region selected in step S114 with the processing target image (step S115). The image synthesis unit 24 further adds information (e.g., class and coordinate) related to the image of the target region to the information related to the image in the target processing image.

When the condition 2 is satisfied and the loop B ends (e.g., a predetermined number of target regions are synthesized), the data set generation control unit 21 adds the processing target image (and information related to the processing target image) to the data set (step S116).

When the condition 1 is satisfied and the loop A ends (e.g., a predetermined number of processing target images are added to the data set), the data set generation unit 20 outputs the data set and ends the operation.

On the basis of the above operation, the data set generation unit 20 generates the data set used by the learning processing unit 30 for machine learning.

[Description of Effects]

Next, effects of the first example embodiment will be described.

The information processing device 1 according to the first example embodiment can achieve an effect of improving use efficiency of the calculation resource in machine learning.

The reason is as follows.

The information processing device 1 includes the learning control unit 10, the data set generation unit 20, and the learning processing unit 30. The data set generation unit 20 is controlled by the learning control unit 10 and generates the data set used by the learning processing unit 30. The data set generation unit 20 includes the data set generation control unit 21, the base image selection unit 22, the target region selection unit 23, and the image synthesis unit 24. The base image selection unit 22 selects a base image from a base data set that is a set of images including a target region that includes an object that is a target of machine learning and a background region that does not include an object that is a target of the machine learning, and generates a processing target image that is a duplicate of the selected base image. The target region selection unit 23 selects a target region included in another image included in the base data set. The image synthesis unit 24 synthesizes the image of the selected target region with the processing target image. The data set generation control unit 21 controls the base image selection unit 22, the target region selection unit 23, and the image synthesis unit 24 to generate a data set that is a set of processing target images in which a predetermined number of target regions are synthesized.

The data set generation unit 20 of the first example embodiment configured as described above generates the data set used for machine learning on the basis of the base data set. The data set generation unit 20 selects an image (base image) from the base data set, and generates a processing target image in which an image of a target region in another image included in the base data set is synthesized with a background portion (region that is not a target region) of the selected base image. Then, the data set generation unit 20 generates a data set including the generated processing target image as a target of machine learning.

The data set generation unit 20 generates a processing target image having a smaller background region and a larger target region compared with the base image of the duplication source, and generates a data set including the generated processing target image. That is, the data set generated by the data set generation unit 20 includes an image having less background portions that cause a decrease in use efficiency of the calculation resource in machine learning compared with the base data set.

Then, the learning processing unit 30 of the information processing device 1 according to the first example embodiment executes machine learning by using the data set generated by the data set generation unit 20. Therefore, the information processing device 1 can obtain an effect of improving use efficiency of the calculation resource in machine learning.

The processing target image includes a larger number of target regions used for machine learning than those in the base image that is the duplication source. Therefore, by using the data set, the learning processing unit 30 can learn a similar number of target regions even using a smaller number of images as compared with the case of using the base data set. That is, the number of images included in the data set may be smaller than the number of images included in the base data set. As a result, the information processing device 1 according to the first example embodiment can shorten the processing time in machine learning. Thus, the information processing device 1 can further improve use efficiency of the calculation resource in machine learning.

When the image including the target region to be synthesized and the processing target image have a large background deviation, a portion in which the target region in the processing target region is synthesized may become an unnatural image. In this case, there is a possibility that the learning processing unit 30 of the information processing device 1 cannot correctly execute machine learning or executes machine learning with low accuracy.

Therefore, the base data set used by the data set generation unit 20 is desirably a data set (e.g., a data set of images captured by a fixed camera) including many images with similar backgrounds.

Therefore, in a case where the base data set includes images of different backgrounds, the data set generation unit 20 of the information processing device 1 is only required to divide the image into subsets (image-groups having similar backgrounds) on the basis of the backgrounds, and generate the processing target image by using the images in the subsets.

In this case, the target region selected for synthesizing is assumed to have a small difference from the pixels at the boundary and the periphery at the synthesis position in the processing target image. Therefore, the processing target image to be generated is an image that reduces an error in machine learning. That is, in a case where the processing target image is generated using images having similar backgrounds, the data set generation unit 20 can generate a more appropriate data set.

[Variations]

In the above description, the data set generation unit 20 uses one base data set. However, the first example embodiment is not limited to this. The data set generation unit 20 may generate a data set to become a target of machine learning by using a plurality of base data sets.

In the above description, the data set generation unit 20 receives, as a parameter, the number of images included in the data set to be generated. However, the first example embodiment is not limited to this.

The data set generation unit 20 may dynamically determine the number of images to be generated.

For example, the data set generation unit 20 may generate images at a predetermined ratio to the number of images included in the base data set as the data set used for machine learning.

Alternatively, for example, the data set generation unit 20 may end the generation of the processing target image when any of the following conditions or a combination of conditions is satisfied in “operation of generation of data set (specifically, the loop A illustrated in FIG. 4)”.

(1) A case where the total number of target regions or the total number of synthesized target regions exceeds a predetermined value in the entire data set being generated.

(2) A case where the total of areas of the target regions or the total of areas of the synthesized target regions exceeds a predetermined value in the entire data set being generated.

(3) A case where the ratio of the area between the target region and the background region exceeds a predetermined value in the entire data set being generated.

The data set generation unit 20 may receive, as a parameter, a value for determination under the above condition, or may hold the value in advance. For example, the data set generation unit 20 may receive a value for determination from the operator prior to the operation. Alternatively, the data set generation unit 20 may calculate the above value by using any of the received parameters.

The data set generation unit 20 may dynamically determine or change parameters other than the number of images included in the data set.

The case where the first example embodiment generates the data set used for a task such as an object detection task having a heavier load than a general task has been described so far. However, the first example embodiment is not limited to the object detection task. The first example embodiment may be used for a task different from the object detection task.

[Hardware Configuration]

The example in which the learning control unit 10, the data set generation unit 20, the learning processing unit 30, and the data set storage unit 40 are included in the same device (the information processing device 1) has been described above. However, the first example embodiment is not limited to this.

For example, the information processing device 1 may be configured by connecting, via a predetermined network, devices including functions of the configuration.

Each component of the information processing device 1 may be configured by a hardware circuit.

Alternatively, in the information processing device 1, a plurality of components may be configured by one piece of hardware.

Alternatively, the information processing device 1 may be implemented as a computer device including a CPU, a read only memory (ROM), and a random access memory (RAM). In addition to the above configuration, the information processing device 1 may be implemented as a computer device including an input and output circuit (IOC). In addition to the above configuration, the information processing device 1 may be implemented as a computer device including a network interface circuit (NIC).

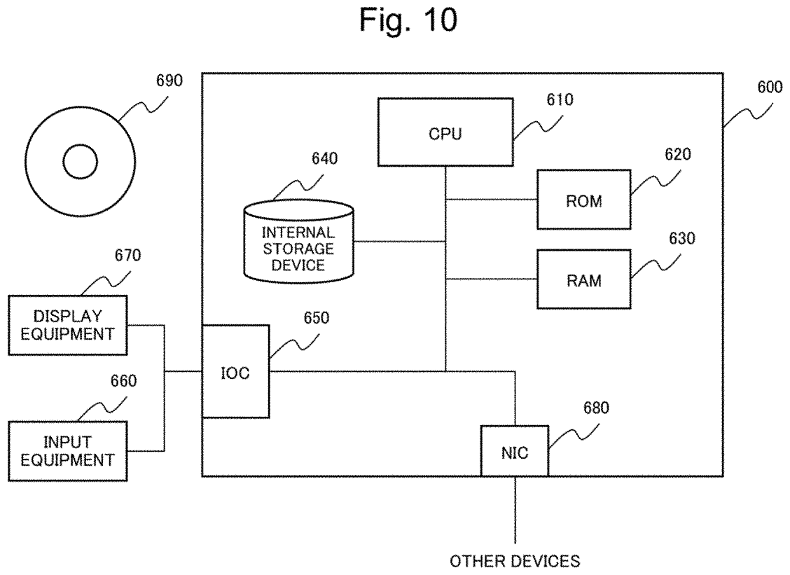

FIG. 10 is a block diagram illustrating the configuration of an information processing device 600, which is an example of the hardware configuration of the information processing device 1.

The information processing device 600 includes a CPU 610, a ROM 620, a RAM 630, an internal storage device 640, an IOC 650, and an NIC 680, and constitutes a computer device.

The CPU 610 reads a program from the ROM 620 and/or the internal storage device 640. Then, the CPU 610 controls the RAM 630, the internal storage device 640, the IOC 650, and the NIC 680 on the basis of the read program. Then, the computer device including the CPU 610 controls these components and implements the functions as the learning control unit 10, the data set generation unit 20, and the learning processing unit 30 illustrated in FIG. 1. The computer device including the CPU 610 controls these components and implements the functions as the data set generation control unit 21, the base image selection unit 22, the target region selection unit 23, and the image synthesis unit 24 illustrated in FIG. 2.

When implementing each function, the CPU 610 may use the RAM 630 or the internal storage device 640 as a temporary storage medium of the program.

By using a storage medium reading device not illustrated, the CPU 610 may read the program included in a storage medium 690 storing the program in a computer readable manner. Alternatively, the CPU 610 may receive, via the NIC 680, a program from an external device not illustrated, store the program in the RAM 630 or the internal storage device 640, and operate on the basis of the stored program.

The ROM 620 stores a program executed by the CPU 610 and fixed data. The ROM 620 is, for example, a programmable-ROM (P-ROM) or a flash ROM.

The RAM 630 temporarily stores a program executed by the CPU 610 and data. The RAM 630 is, for example, a dynamic-RAM (D-RAM).

The internal storage device 640 stores data and programs to be stored for a long period of time by the information processing device 600. The internal storage device 640 operates as the data set storage unit 40. The internal storage device 640 may operate as a temporary storage device of the CPU 610. The internal storage device 640 is, for example, a hard disk device, a magneto-optical disk device, a solid state drive (SSD), or a disk array device.

The ROM 620 and the internal storage device 640 are non-transitory recording media. On the other hand, the RAM 630 is a transitory recording medium. The CPU 610 is operable on the basis of a program stored in the ROM 620, the internal storage device 640, or the RAM 630. That is, the CPU 610 is operable using a non-transitory recording medium or a transitory recording medium.

The IOC 650 mediates data among the CPU 610 and, input equipment 660 and display equipment 670. The IOC 650 is, for example, an IO interface card or a universal serial bus (USB) card. The IOC 650 may use not only wired communication such as USB but also wireless communication.

The input equipment 660 is equipment that receives an instruction from the operator of the information processing device 600. For example, the input equipment 660 receives a parameter. The input equipment 660 is, for example, a keyboard, a mouse, or a touchscreen.

The display equipment 670 is equipment that displays information to the operator of the information processing device 600. The display equipment 670 is, for example, a liquid crystal display, an organic electroluminescence display, or electronic paper.

The NIC 680 relays exchange of data with an external device not illustrated via a network. The NIC 680 is, for example, a local area network (LAN) card. The NIC 680 may use not only wired communication but also wireless communication.

The information processing device 600 configured in this manner can achieve effects similar to those of the information processing device 1.

The reason is that the CPU 610 of the information processing device 600 can achieve the similar functions as those of the information processing device 1 on the basis of the program.

### Second Example Embodiment

An information processing device 1B according to the second example embodiment generates a data set on the basis of a result of machine learning using a base data set.

The second example embodiment will be described with reference to the drawings. In the drawings referred to in the description of the second example embodiment, the similar configurations and operations to those of the first example embodiment are denoted by the same reference numerals, and a detailed description will be omitted.

[Description of Configuration]

The configuration of the information processing device 1B according to the second example embodiment will be described with reference to the drawings. The information processing device 1B may be configured using a computer device as illustrated in FIG. 10, similarly to the first example embodiment.

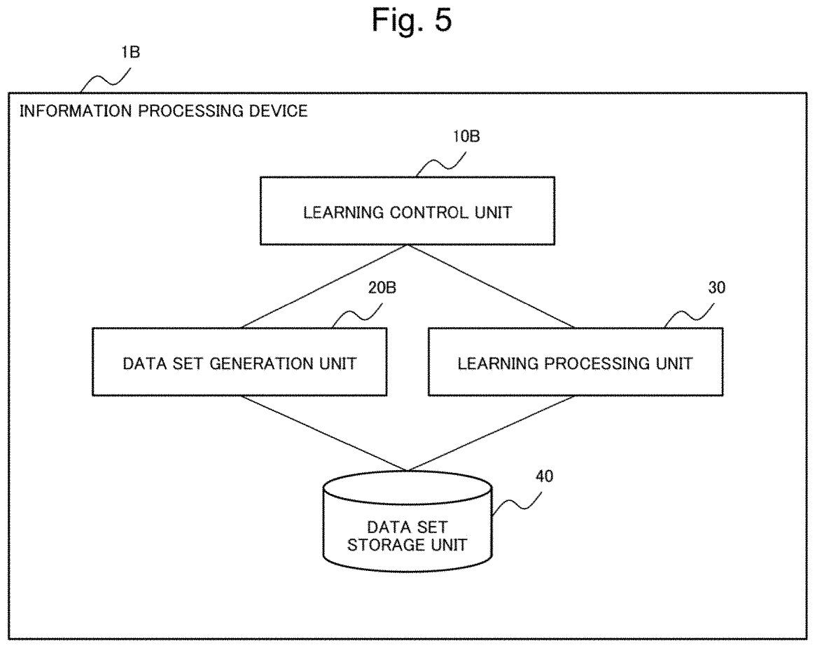

FIG. 5 is a block diagram illustrating an example of the configuration of an information processing device 1B according to the second example embodiment.

The information processing device 1B illustrated in FIG. 5 includes a learning control unit 10B, a data set generation unit 20B, a learning processing unit 30, and a data set storage unit 40.

Since the data set storage unit 40 is similar to that of the first example embodiment, a detailed description will be omitted.

The learning processing unit 30 executes machine learning similarly to the learning processing unit 30 of the first example embodiment. However, as described later, the learning processing unit 30 executes machine learning using the base data set in addition to machine learning using the data set. The learning processing unit 30 executes similar machine learning in the machine learning using the data set and the machine learning using the base data set except for a difference in target data.

The learning processing unit 30 evaluates a result of at least machine learning using the base data set.

The learning control unit 10B executes the following control in addition to the control in the learning control unit 10 of the first example embodiment.

First, the learning control unit 10B causes the learning processing unit 30 to execute machine learning using the base data set and evaluation on the result of the machine learning. Then, the learning control unit 10B instructs the data set generation unit 20B to generate a data set by using the base data set and the evaluation result. Then, the learning control unit 10B causes the learning processing unit 30 to execute machine learning using the generated data set.

The learning control unit 10B may control the machine learning for the base data set in the learning processing unit 30 and the generation of the data set in the data set generation unit 20B so as to operate for each subset of the base data set.

Next, the configuration of the data set generation unit 20B in the second example embodiment will be described with reference to the drawings.

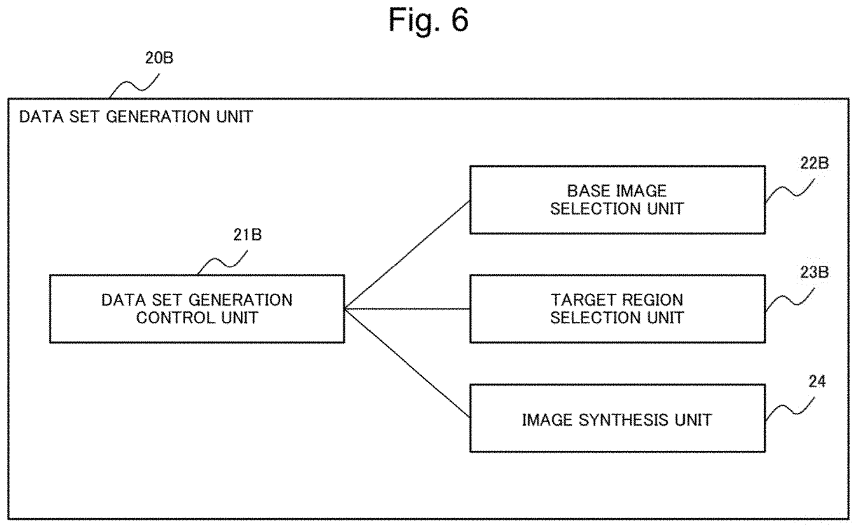

FIG. 6 is a block diagram illustrating an example of the configuration of the data set generation unit 20B according to the second example embodiment.

The data set generation unit 20B includes a data set generation control unit 21B, a base image selection unit 22B, a target region selection unit 23B, and an image synthesis unit 24.

In addition to the control in the data set generation control unit 21 of the first example embodiment, the data set generation control unit 21B controls generation of the data set so as to be based on the evaluation of the result of the machine learning using the base data set in the learning processing unit 30.

The data set generation control unit 21B may determine a parameter related to generation of the data set with reference to evaluation of the result of machine learning using the base data set.

For example, the data set generation control unit 21B may execute the following operations.

(1) The data set generation control unit 21B changes the number of images to be generated for a subset having low recognition accuracy in evaluation of machine learning using the base data set. For example, the data set generation control unit 21B may increase the number of images included in the data set to be generated for the subset having low recognition accuracy. That is, by preferentially using an image of the subset having low recognition accuracy, the data set generation control unit 21B may generate a data set that becomes the target of machine learning. In this case, the learning processing unit 30 learns a data set including many images included in the subset having low recognition accuracy. As a result, the recognition accuracy in the subset having low recognition accuracy is improved.

(2) The data set generation control unit 21B changes the maximum number of target regions to be synthesized for a subset, a class, or the like having low recognition accuracy in evaluation of machine learning using the base data set. For example, the data set generation control unit 21B may increase the number of target regions to be synthesized for the subset having low recognition accuracy. Also in this case, the recognition accuracy in the subset having low recognition accuracy is improved.

The base image selection unit 22B selects the base image by using the result of machine learning using the base data set in addition to the selection operation in the base image selection unit 22 of the first example embodiment. For example, the base image selection unit 22B may select the base image by using any of the following selections or a combination of selections.

(1) Preferentially select an image in a subset including an image having low recognition accuracy in evaluation of machine learning using the base data set.

(2) Preferentially select an image in a subset having low recognition accuracy in evaluation of machine learning using the base data set.

(3) Preferentially select an image including many target regions including the detection target object of the same class as the class of the detection target object having low recognition accuracy in evaluation of machine learning using the base data set.

(4) Preferentially select an image including many target regions of a size having low recognition accuracy in evaluation of machine learning using the base data set.

The base image selection unit 22B may use a condition that “loss (e.g., information loss) in machine learning is large” instead of the determination condition that “recognition accuracy is low”.

The target region selection unit 23B selects the target region by using the result of machine learning using the base data set in addition to the operation in the target region selection unit 23 of the first example embodiment. For example, the target region selection unit 23B may select the target region by using any of the following selections or a combination of selections.

(1) Preferentially select a target region included in an image having low recognition accuracy in evaluation of machine learning using the base data set.

(2) Preferentially select a target region of an image included in a class having low recognition accuracy in evaluation of machine learning using the base data set.

(3) Preferentially select a target region of a size having low recognition accuracy in evaluation of machine learning using the base data set.

(4) Preferentially select a target region having low recognition accuracy in evaluation of machine learning using the base data set.

The image synthesis unit 24 synthesizes the processing target image and the target region selected on the basis of the evaluation result of the base data set described above. For example, the image synthesis unit 24 synthesizes a processing target image that is a duplication of a base image having low recognition accuracy in machine learning using the base data set with a target region having low recognition accuracy.

As a result, the data set generation unit 20B generates a data set including an image appropriate as a target of machine learning in the learning processing unit 30.

Any one of the base image selection unit 22B and the target region selection unit 23B may use the evaluation result of the base data set.

[Description of Operation]

Next, the operation of the information processing device 1B according to the second example embodiment will be described with reference to the drawings.

(A) Operation of Machine Learning

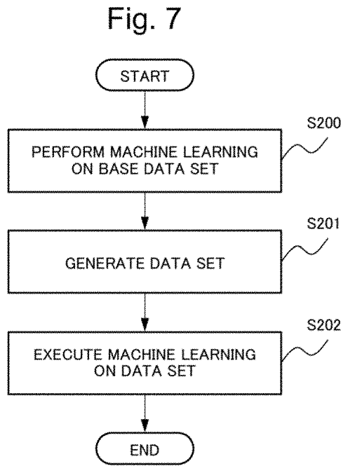

FIG. 7 is a flowchart illustrating an example of the operation of machine learning in the information processing device 1B according to the second example embodiment.

The information processing device 1B starts operation in response to a predetermined condition. The information processing device 1B starts machine learning in response to an instruction from the operator, for example. In this case, at the start of machine learning, the information processing device 1B may receive another parameter in addition to the parameter necessary for the machine learning from the operator as a parameter related to the machine learning. For example, the information processing device 1B may receive, from the operator, the base data set and a parameter related to generation of the data set.

The learning control unit 10B instructs the learning processing unit 30 to perform machine learning using the base data set. The learning processing unit 30 executes machine learning by using the base data set (step S200). The learning processing unit 30 may receive a parameter used for machine learning.

The learning control unit 10B instructs the data set generation unit 20 to generate a data set based on the base data set and the result of the machine learning in step S200. The data set generation unit 20B generates a data set on the basis of the base data set and the result of machine learning of the base data set (step S201). The data set generation unit 20 may receive a parameter for generating the data set.

The learning control unit 10B instructs the learning processing unit 30 to perform machine learning using the generated data set. The learning processing unit 30 executes machine learning by using the data set generated in step S201 (step S202). The learning processing unit 30 may receive a parameter used for machine learning.

By using the above operation, the data set generation unit 20B generates a data set.

[Description of Effects]

Next, effects of the second example embodiment will be described.

The second example embodiment can achieve the following effects in addition to the similar effects to those of the first example embodiment (such as improvement in use efficiency of the calculation resource in machine learning).

The second example embodiment operates using the result of machine learning using the base data set. Therefore, the second example embodiment achieve an effect of generating a more appropriate data set.

For example, the second example embodiment generates a data set to be a target of the machine learning by preferentially using a target region of a subset having low recognition accuracy, a target region of a class having low recognition accuracy, or a target region of an image having low recognition accuracy in evaluation of machine learning of the base data set. Thus, the second example embodiment generates a data set including a large number of target regions having low recognition accuracy and desirable to be targets of learning. Therefore, the learning processing unit 30 can improve recognition accuracy in the learning result in machine learning using the generated data set.

[Variations]

In the description of the second example embodiment so far, the data set generation unit 20B generates the data set once. However, the second example embodiment is not limited to this.

For example, the learning control unit 10B may perform control such that the data set generation unit 20B generates the data set again on the basis of the result of evaluation of the result of machine learning using the data set generated in the learning processing unit 30. In this case, the data set generation unit 20B generates the data set by using the evaluation result of the machine learning using the data set in the learning processing unit 30. As a result, the data set generation unit 20B generates a data set further suitable for machine learning.

### Third Example Embodiment

An outline of the above example embodiment will be described as a third example embodiment.

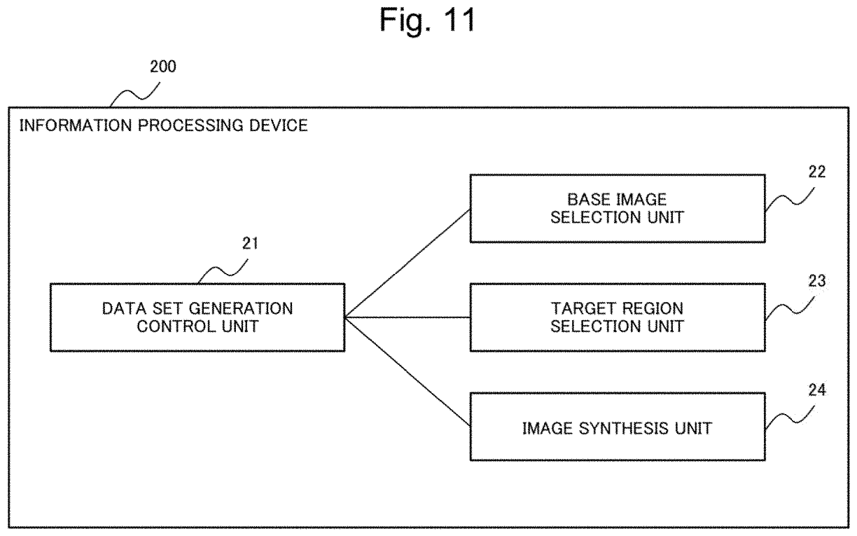

FIG. 11 is a block diagram illustrating the configuration of an information processing device 200, which is an example of an outline of an example embodiment. The information processing device 200 may be configured using a computer device as illustrated in FIG. 10, similarly to the first and second example embodiments.

The information processing device 200 includes a data set generation control unit 21, a base image selection unit 22, a target region selection unit 23, and an image synthesis unit 24. The components included in the information processing device 200 operate similarly to the components included in the data set generation unit 20 in the information processing device 1.

That is, the information processing device 200 generates a data set for machine learning by using a base data set stored in an external device not illustrated or the like. The information processing device 200 outputs the generated data set to an external device (e.g., a machine learning device or a storage device) not illustrated.

[Description of Effects]

Similarly to the information processing device 1 of the first example embodiment, the information processing device 200 can achieve an effect of improving use efficiency of the calculation resource in machine learning.

The reason is as follows.

The information processing device 200 includes a data set generation control unit 21, a base image selection unit 22, a target region selection unit 23, and an image synthesis unit 24. The base image selection unit 22 selects a base image from a base data set that is a set of images including a target region that includes an object that is a target of machine learning and a background region that does not include an object that is a target of the machine learning, and generates a processing target image that is a duplicate of the selected base image. The target region selection unit 23 selects a target region included in another image included in the base data set. The image synthesis unit 24 synthesizes the image of the selected target region with the processing target image. The data set generation control unit 21 controls the base image selection unit 22, the target region selection unit 23, and the image synthesis unit 24 to generate a data set that is a set of processing target images in which a predetermined number of target regions are synthesized.

As described above, the information processing device 200 operates similarly to the data set generation unit 20 in the first example embodiment. Therefore, the data set generated by the information processing device 200 includes less background portions and more target regions compared with the base data set. Therefore, the device using the data set generated by the information processing device 200 can improve use efficiency of the calculation resource in machine learning.

The information processing device 200 has the minimum configuration of the above example embodiment.

[Information Processing System]

Next, as a description of the information processing device 200, an information processing system 100 that executes machine learning using the data set generated by the information processing device 200 will be described.

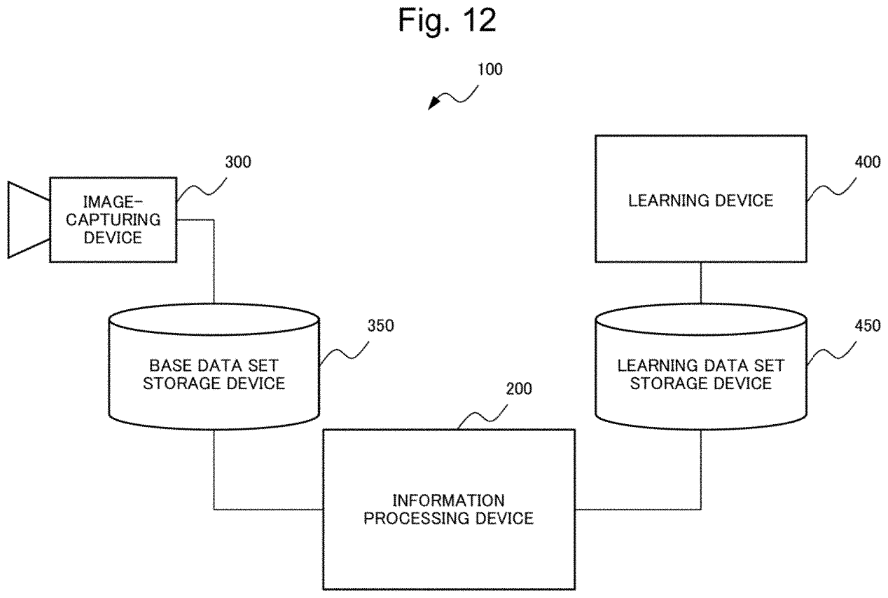

FIG. 12 is a block diagram illustrating an example of the information processing system 100 including the information processing device 200.

The information processing system 100 includes the information processing device 200, an image-capturing device 300, a base data set storage device 350, a learning data set storage device 450, and a learning device 400. In the following description, it is assumed that parameters necessary for the operation have been set in the information processing device 200 in advance.

The image-capturing device 300 captures an image serving as a base data set.

The base data set storage device 350 stores the captured image as the base data set.

The information processing device 200 generates a data set by using the image stored in the base data set storage device 350 as the base data set. Then, the information processing device 200 stores the generated data set in the learning data set storage device 450.

The learning data set storage device 450 stores the data set generated by the information processing device 200.

The learning device 400 executes machine learning by using the data set stored in the learning data set storage device 450.

The learning device 400 executes machine learning by using the data set generated by the information processing device 200. Therefore, the learning device 400 can execute machine learning with improved use efficiency of the calculation resource, similarly to the learning processing unit 30 in the first example embodiment and the learning processing unit 30B in the second example embodiment.

While the invention has been particularly shown and described with reference to exemplary embodiments thereof, the invention is not limited to these example embodiments. It will be understood by those of ordinary skill in the art that various changes in form and details may be made therein without departing from the spirit and scope of the present invention as defined by the claims.

### REFERENCE SIGNS LIST

1 information processing device
1B information processing device
10 learning control unit
10B learning control unit
20 data set generation unit
20B data set generation unit
21 data set generation control unit
21B data set generation control unit
22 base image selection unit
22B base image selection unit
23 target region selection unit
23B target region selection unit
24 image synthesis unit
30 learning processing unit
40 data set storage unit
100 information processing system
200 information processing device
300 image-capturing device
350 base data set storage device
400 learning device
450 learning data set storage device
600 information processing device
610 CPU
620 ROM
630 RAM
640 internal storage device
650 IOC
660 input equipment
670 display equipment
680 NIC
690 storage medium

What is claimed is:

1. An information processing device comprising:
a memory; and
at least one processor coupled to the memory,
the processor performing operations, the operations comprising:
selecting a base image from a base data set that is a set of images including a target region that includes an object that is a target of machine learning and a background region that does not include an object that is a target of the machine learning;
generating a processing target image that is a duplicate of the selected base image;
selecting the target region included in another image included in the base data set;
synthesizing an image of the selected target region with the processing target image; and
generating a data set that is a set of the processing target images in which a predetermined number of the target regions are synthesized.

2. The information processing device according to claim 1, wherein the operations further comprise:
dividing the images included in the base data set into a plurality of image-groups based on a predetermined criterion, and
selecting the target region from the image included in same image-group as the base selected image.

3. The information processing device according to claim 2, wherein the operations further comprise:
using similarity of a background region in the image as a criterion for dividing the image included in the base data set into the image-groups.

4. The information processing device according to claim 1, wherein the operations further comprise:
evaluating the machine learning using the base data set, and a result of the machine learning using the base data set, wherein the operations further comprise:
selecting at least one of the base images, and
the target region by using a result of evaluation.

5. The information processing device according to claim 4, wherein
recognition accuracy of an object in a result of the machine learning using the base data set is used as a result of the evaluation.

6. An information processing method comprising:
selecting a base image from a base data set that is a set of images including a target region that includes an object that is a target of machine learning and a background region that does not include an object that is a target of the machine learning;
generating a processing target image that is a duplicate of the selected base image;
selecting the target region included in another image included in the base data set;
synthesizing an image of the selected target region with the processing target image; and
generating a data set that is a set of the processing target images in which a predetermined number of the target regions are synthesized.

7. A non-transitory computer-readable recording medium embodying a program, the program causing a computer to perform a method, the method comprising:
selecting a base image from a base data set that is a set of images including a target region that includes an object that is a target of machine learning and a background region that does not include an object that is a target of the machine learning;
generating a processing target image that is a duplicate of the selected base image;
selecting the target region included in another image included in the base data set;
synthesizing an image of the selected target region with the processing target image; and
generating a data set that is a set of the processing target images in which a predetermined number of the target regions are synthesized.
